(19) United States
(12) Patent Application Publication
(10) Pub. No.: US 2026/0216900 A1
(43) Pub. Date: Jul. 30, 2026

(54) ROBOT JOINT STRUCTURE AND ROBOT

(71) Applicant: KAWASAKI JUKOGYO KABUSHIKI KAISHA, Kobe-shi, Hyogo (JP)

(72) Inventors: Junichi KARASUYAMA, Kobe-shi (JP); Masayuki KAMON, Kobe-shi (JP)

(73) Assignee: KAWASAKI JUKOGYO KABUSHIKI KAISHA, Kobe-shi, Hyogo (JP)

(21) Appl. No.: 19/143,127

(22) PCT Filed: Dec. 28, 2023
(86) PCT No.: PCT/JP2023/047229

§ 371 Date: Jun. 25, 2025

(30) Foreign Application Priority Data
Dec. 28, 2022 (JP) 2022-211649

(51) Int. Cl. B25J 17/00; B25J 19/00

(52) U.S. Cl. CPC B25J 17/00; B25J 19/0075

(57) ABSTRACT

A first link (11) and a second link (12); a joint (20) that connects the first link (11) and the second link (11) to each other; a driver (30) that rotates the first link (11) and the second link (12) relative to each other; and a movable cover (40) that is configured movably with respect to the joint (20) to move in response to relative rotation between the first link (11) and the second link (12) to cover the joint (20) are provided.

### TECHNICAL FIELD

The present disclosure relates to a robot joint structure and a robot.

### BACKGROUND ART

Robots are known in the art. For example, the above Japanese Patent Laid-Open Publication No. JP2006-88258 discloses a bipedal mobile robot including two legs. Each of the two legs includes a thigh and a lower leg as links. The thigh and the lower leg are connected to each other in a continuous manner by a knee joint. The knee joint is rotatably operated by driving a knee joint actuator, which is an electric motor.

### PRIOR ART

### Patent Document

Patent Document 1: Japanese Patent Laid-Open Publication No. JP2006-88258

### Summary of the Invention

Although not stated in the above Japanese Patent Laid-Open Publication No. JP2006-88258, a cover is provided at a joint such as the knee joint, which rotatably connects the links to each other, to cover the joint in order to protect the joint in some cases. In such a case, a position of a part to be protected, such as a rotation shaft in the joint, may change as the links rotate relative to each other. To address this, the cover covering the joint is designed to be large enough to cover the joint even when the position of the part to be protected changes.

The present disclosure is intended to solve the above problem, and one object of the present disclosure is to provide a robot joint structure and a robot capable of preventing an increase in the size of a cover for a joint that connects links to each other.

A robot joint structure according to a first aspect of the present disclosure includes a first link and a second link; a joint that connects the first link and the second link to each other; a driver that rotates the first link and the second link relative to each other; and a movable cover that is configured movably with respect to the joint to move in response to relative rotation between the first link and the second link to cover the joint.

In the robot joint structure according to the first aspect of the present disclosure, as discussed above, the movable cover is configured movably with respect to the joint to move in response to relative rotation between the first link and the second link to cover the joint. Accordingly, because the movable cover moves in response to the relative rotation between the first link and the second link, even when the position of a part to be protected, such as a rotation shaft in the joint, changes, the movable cover can move in response to changes in the position of the part to be protected. Consequently, the part to be protected at the joint can be covered by moving the movable cover even when the position of the part to be protected changes without increasing the size of the movable cover. Therefore, it is possible to prevent an increase in the size of the cover for the joint that connects the links to each other.

A robot according to a second aspect of the present disclosure includes a first link and a second link; a joint that connects the first link and the second link to each other; a driver that rotates the first link and the second link relative to each other; and a movable cover that is configured movably with respect to the joint to move in response to relative rotation between the first link and the second link to cover the joint.

In the robot according to the second aspect of the present disclosure, as discussed above, the movable cover is configured movably with respect to the joint to move in response to relative rotation between the first link and the second link to cover the joint. Accordingly, because the movable cover moves in response to the relative rotation between the first link and the second link, even when the position of a part to be protected, such as a rotation shaft in the joint, changes, the movable cover can move in response to changes in the position of the part to be protected. Consequently, the part to be protected at the joint can be covered by moving the movable cover even when the position of the part to be protected changes without increasing the size of the movable cover. Therefore, it is possible to provide a robot capable of preventing an increase in the size of the cover for the joint connecting the links to each other.

According to the present disclosure, it is possible to prevent an increase in the size of the cover for the joint connecting the links to each other.

### BRIEF DESCRIPTION OF THE DRAWINGS

FIG. 1 is a perspective view showing a humanoid robot according to one embodiment of the present disclosure.

FIG. 2 is a block diagram showing the overall configuration of robot joint structure in the humanoid robot.

FIG. 3 is a perspective view schematically showing the configuration of a joint and a driver.

FIG. 4 is a side view illustrating the configuration of the joint and the driver.

FIG. 5 is a schematic diagram illustrating a movable cover and a fixed cover when the rotation angle is 0 degrees.

FIG. 6 is a schematic diagram illustrating a movable cover and a fixed cover when the rotation angle is 60 degrees.

FIG. 7 is a view illustrating the arrangement of the movable cover when the rotation angle is 0 degrees.

FIG. 8 is a schematic diagram illustrating the movable cover and the fixed cover when the rotation angle is 100 degrees.

FIG. 9 is a view illustrating the arrangement of the movable cover when the rotation angle is 100 degrees.

FIG. 10 is a schematic diagram illustrating a movable cover and a fixed cover when the rotation angle is 150 degrees.

FIG. 11 is a front view illustrating the widths of the movable cover and the fixed cover.

FIG. 12 is a side view illustrating a robot according to a modified example of the one embodiment of the present disclosure.

### MODES FOR CARRYING OUT THE INVENTION

The following description will describe one embodiment embodying the present disclosure with reference to the drawings.

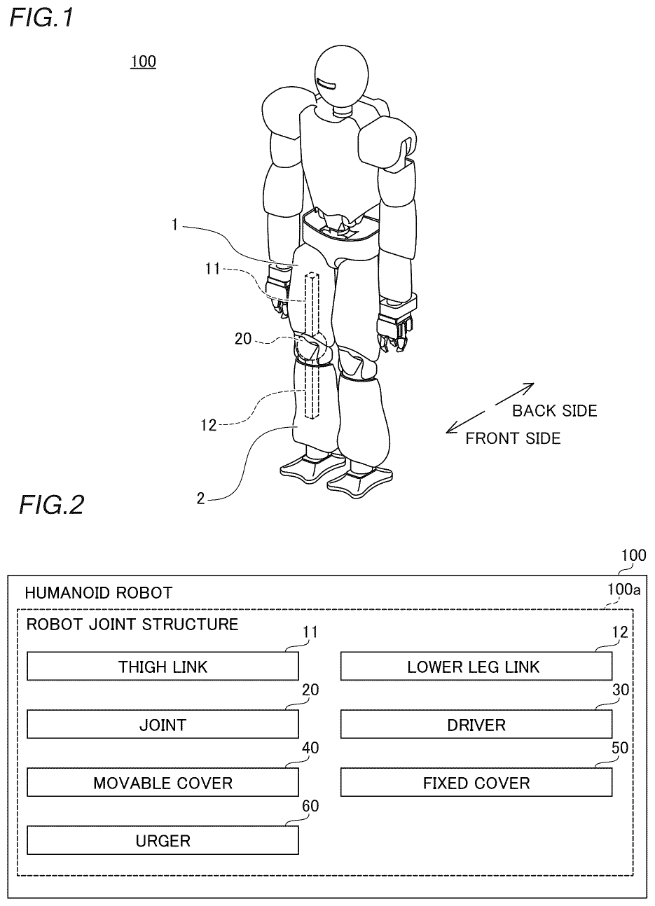

The following description describes a configuration of the humanoid robot 100 according to an embodiment with reference to FIGS. 1 to 11. The humanoid robot 100 is also referred to as a humanoid. Here, the humanoid robot 100 is an example of a robot.

As shown in FIG. 1, the humanoid robot 100 includes a pair of thighs 1 and a pair of lower legs 2, corresponding to those of a human. The thigh 1 corresponds to a human thigh. The lower leg 2 corresponds to a human lower leg. Here, the pair of thighs 1 have similar structures, and the pair of lower legs 2 also have similar structures; accordingly, the following description will describe the thigh 1 and the lower leg 2 of only one leg.

The humanoid robot 100 includes a thigh link 11 and a lower leg link 12. The thigh link 11 and the lower leg link 12 are rod-shaped components in a certain portion of the humanoid robot 100. Specifically, the thigh link 11 is a component of the thigh 1 in the humanoid robot 100.

The lower leg link 12 is a component of the lower leg 2 in the humanoid robot 100. The thigh link 11 and the lower leg link 12 include metal components such as aluminum or stainless steel, for example. Here, the thigh link 11 is an example of a first link. The lower leg link 12 is an example of a second link.

The joint 20 connects the thigh link 11 to the lower leg link 12. The joint 20 is a knee joint in the humanoid robot 100. The thigh link 11 and the lower leg link 12 rotate relative to each other as the joint 20 rotates.

Specifically, the thigh link 11 and the lower leg link 12 rotate relative to each other to perform bending and stretching motions. The relative rotation of the thigh link 11 and the lower leg link 12 allows the humanoid robot 100 to walk on two legs.

As shown in FIG. 2, the humanoid robot 100 includes a robot joint structure 100a. The robot joint structure 100a according to this embodiment includes the thigh link 11, the lower leg link 12, and the joint 20. The robot joint structure 100a include a driver 30, a movable cover 40, a fixed cover 50, and an urger 60.

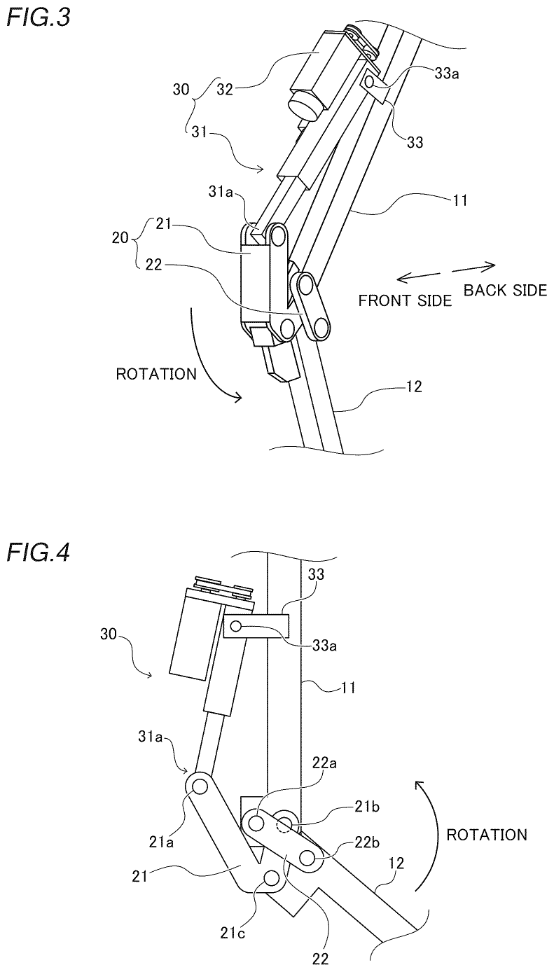

As shown in FIG. 3, the driver 30 includes a linear movement mechanism 31 and an electric motor 32. For example, the linear movement mechanism 31 includes a ball-screw mechanism. The linear movement mechanism 31 moves linearly using the rotational drive of the electric motor 32 as its drive source. In the driver 30, the rotation of the electric motor 32 is transmitted via a belt to the linear movement mechanism 31, causing a distal end 31a of the linear movement mechanism 31 to move linearly. Also, the linear movement mechanism 31 and the electric motor 32 are arranged rotatably relative to the thigh link 11.

Specifically, the linear movement mechanism 31 and the electric motor 32 of the driver 30 are arranged on the thigh link 11 via a support 33. The driver 30 rotates relative to the support 33 using a shaft center 33a as its rotation axis. Also, the linear movement mechanism 31 is oriented along the rod-shaped thigh link 11, which is a part of the thigh 1. The distal end 31a of the linear movement mechanism 31 moves linearly in an extension direction of the rod-shaped thigh link 11. Also, in the driver 30, the linearly movable distal end 31a of the linear movement mechanism 31 is connected to the joint 20. Specifically, the distal end 31a is rotatably connected to the joint 20. The linear movement mechanism 31 rotates the joint 20 by moving linearly. In other words, the driver 30 rotates the joint 20 to cause the thigh link 11 and the lower leg link 12 to rotate relative to each other by linearly moving the distal end 31a of the linear movement mechanism 31. Also, the driver 30 is arranged on a side opposite to a direction of rotation in which the thigh link 11 and the lower leg link 12 are rotated relative to each other to perform a bending motion. In other words, the driver 30 is arranged on a front side with respect to the thigh 1 in the humanoid robot 100.

The joint 20 includes two joint links 21 and 22. The joint link 21 and the joint link 22 are arranged to intersect each other when the thigh link 11 and the lower leg link 12 perform a stretching motion. Each of the joint link 21 and the joint link 22 connects the thigh link 11 and the lower leg link 12 to each other. Also, the joint link 21 is connected to the distal end 31a of the linear movement mechanism 31 of the driver 30. The joint link 21 has a V shape as viewed from a lateral side, which is the left/right-direction side of the humanoid robot 100. Here, the joint link 22 is an example of a third link.

As shown in FIG. 4, specifically, the joint link 21 is rotatably connected to the distal end 31a of the linear movement mechanism 31 of the driver 30 via a shaft 21a. The shaft 21a serves as a rotation axis of the linear movement mechanism 31 and the rotation of the joint link 21. The joint link 21 is rotatably connected to the thigh link 11 via a shaft 21b. The joint link 21 is rotatably connected to the lower leg link 12 via a shaft 21c. In other words, the shaft 21b serves as a rotation axis for rotation of the joint link 21 and the thigh link 11. Also, the shaft 21c serves as a rotation axis of the joint link 21 and the lower leg link 12. Similarly, the joint link 22 is rotatably connected to the thigh link 11 via a shaft 22a. The joint link 22 is rotatably connected to the lower leg link 12 via a shaft 22b. The shaft 22a serves as a rotation axis of the joint link 22 and the thigh link 11. Also, the shaft 22b serves as a rotation axis of the joint link 22 and the lower leg link 12. Each of the shafts 21a, 21b, 21c, 22a and 22b includes, for example, a rod-shaped shaft core and ball bearings. Each of an end of the thigh link 11 on the lower leg link 12 side and an end of the lower leg link 12 on the thigh link 11 side has an L shape. The shaft 21b and the shaft 22a are arranged on the L-shaped end of the lower leg link 12 side of the thigh link 11. Similarly, the shaft 21c and the shaft 22b are arranged on the L-shaped end of the thigh link 11 side of the lower leg link 12.

In the joint structure of the driver 30, the thigh link 11, the lower leg link 12, the joint link 21 and the joint link 22, the joint link 21 rotates as the linear movement mechanism 31 of the driver 30 moves linearly. As the joint link 21 rotates, the lower leg link 12, which is connected to the shaft 21c, rotates relative to the thigh link 11 while being constrained by the joint link 22. In other words, the lower leg link 12 is rotated relative to the thigh link 11 by the movement of the joint link 21 while its orientation is changed by its connection to the joint link 22.

### Cover

As shown in FIG. 5, the humanoid robot 100 includes a thigh cover 13 and a lower leg cover 14. The thigh cover 13 covers the thigh 1. The lower leg cover 14 covers the lower leg 2. Specifically, the thigh cover 13 is a tubular component that covers the thigh link 11 and the driver 30. The lower leg cover 14 is a tubular component that covers the lower leg link 12. The thigh cover 13 and the lower leg cover 14 are formed, for example, of a resin.

In this embodiment, the robot joint structure 100a of the humanoid robot 100 includes the movable cover 40 and the fixed cover 50, which cover the joint 20. The movable cover 40 is arranged movably relative to the joint 20, which is the knee joint. The fixed cover 50 covers the joint 20 while being fixed to the joint 20. The fixed cover 50 is covered by the movable cover 40 when the thigh link 11 and the lower leg link 12 are in a stretched state. The movable cover 40 and the fixed cover 50 are formed, for example, of a resin. Here, the shapes of the thigh link 11, the lower leg link 12, and the fixed cover 50 are schematically shown in FIG. 5.

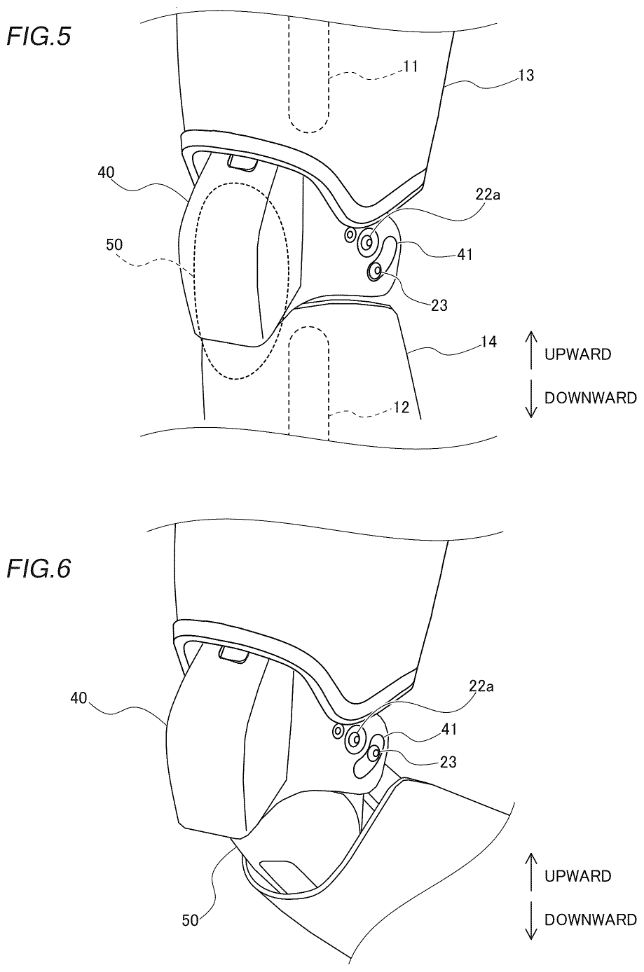

As shown in FIG. 6, the fixed cover 50 is exposed from the movable cover 40 toward the lower leg link 12 when the thigh link 11 and the lower leg link 12 are in a bent state. In other words, the fixed cover 50 is exposed from the movable cover 40 downward, that is, toward a side where the lower leg link 12 is located, when the thigh link 11 and the lower leg link 12 are in the bent state.

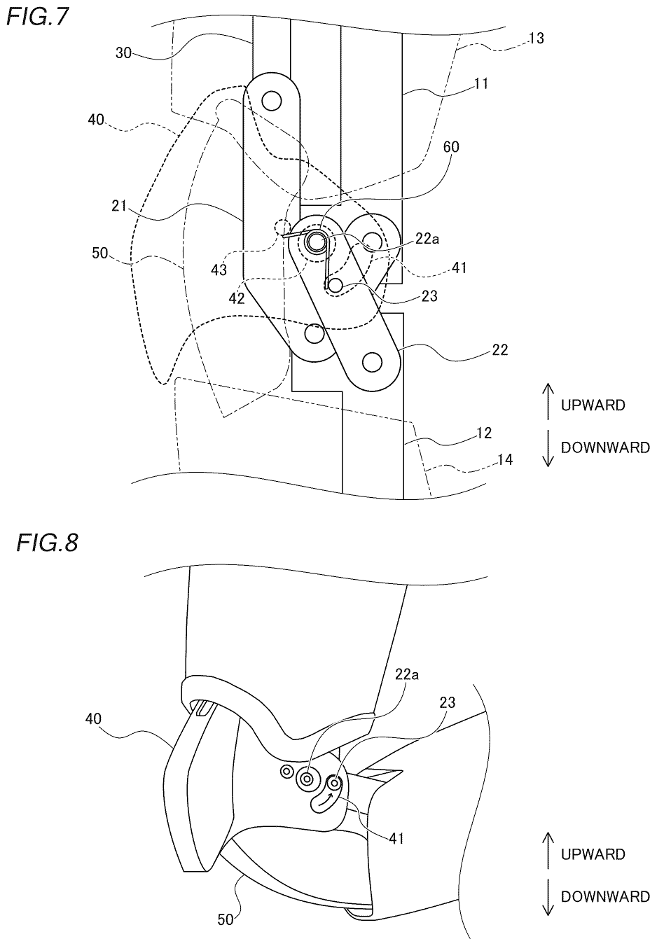

Specifically, as shown in FIG. 7, the movable cover 40 is connected to the shaft 22a, which connects the thigh link 11 to the joint link 22. The movable cover 40 is rotatably connected to the shaft 22a, independently of the thigh link 11 and the joint link 22. The movable cover 40 has a hole 42 through which the shaft 22a passes. The movable cover 40 is rotatably connected to the shaft 22a at the hole 42. In contrast, the fixed cover 50 is fixed to the joint link 21 of the joint 20 by fasteners, such as screws. In other words, the fixed cover 50 moves together with the joint link 21 as the joint link 21 moves.

Also, the movable cover 40 is urged by an urger 60. The urger 60 urges the movable cover 40 upward, that is, toward the thigh link 11 about a rotation axis of the movable cover 40. The urger 60 is, for example, a torsion coil spring. The urger 60 is wound around the shaft 22a in its circumferential direction. The urger 60 is arranged to generate an elastic force as an urging force in the circumferential direction of the shaft 22a. One end of the urger 60, which is the torsion coil spring, engages with a protrusion 23, which will be described later. The other end of the urger 60 engages with the fixed shaft 43 provided on the movable cover 40. The fixed shaft 43 is secured to the inside of the movable cover 40, for example, with a fastener, such as a screw. As a result of the urging force applied by the urger 60 to the fixed shaft 43, the movable cover 40 is urged toward the thigh link 11 and moves together with the thigh link 11 when the rotation angle between the thigh link 11 and the lower leg link 12 is within a predetermined range.

### <Movement of Movable Cover>

In this embodiment, the movable cover 40 moves in response to relative rotation between the thigh link 11 and the lower leg link 12 driven by the driver 30. The movable cover 40 moves to rotate about a rotation axis shared with rotation of the joint link 22 relative to the thigh link 11. Specifically, the movable cover 40 has an arc-shaped elongated hole 41. The joint 20 includes a convex protrusion 23. The protrusion 23 moves in response to the relative rotation between the thigh link 11 and the lower leg link 12 driven by the driver 30. The elongated hole 41 engages with the protrusion 23. The movable cover 40 moves in response to relative rotation between the thigh link 11 and the lower leg link 12 when the protrusion 23 engages with the elongated hole 41. Here, the protrusion 23 is an example of an engager. The elongated hole 41 is an example of an engagee.

Specifically, the protrusion 23 is provided on the joint link 22. As the joint link 22 rotates relative to thigh link 11 about the shaft 22a as its rotation axis, the protrusion 23 rotates about the shaft 22a as its rotation axis. Also, the protrusion 23 moves along the arc-shaped elongated hole 41 within the elongated hole 41 while engaging with the elongated hole 41. The protrusion 23 is positioned at the lower-side one end of the elongated hole 41 when the rotation angle between the thigh link 11 and the lower leg link 12 is 0 degrees as shown in FIG. 5. In addition, the protrusion 23 moves inside the elongated hole 41 to rotate in response to the relative rotation between the thigh link 11 and the lower leg link 12. Here, the state in which the thigh link 11 and the lower leg link 12 are aligned in a substantially straight line is defined as a rotation angle of 0 degrees.

As shown in FIG. 8, the movable cover 40 does not move when the protrusion 23 moves within the elongated hole 41 regardless of the relative rotation between the thigh link 11 and the lower leg link 12 driven by the driver 30. Specifically, the positional relation of the movable cover 40 relative to the thigh link 11 remains unchanged throughout the range of relative rotation angles between the thigh link 11 and the lower leg link 12, from 0 degrees to 100 degrees. Throughout this range, from rotation angles from 0 degrees to 100 degrees, the protrusion 23 rotates within the arc-shaped elongated hole 41 about the shaft 22a. At a rotation angle of 100 degrees, the protrusion 23 comes into contact with the upward-side one end of the inner circumferential surface of the elongated hole 41. For example, when the rotation angle between the thigh link 11 and the lower leg link 12 is 60 degrees as shown in FIG. 6, the lower leg link 12 and the fixed cover 50 rotate relative to the thigh link 11, while the movable cover 40 remains stationary relative to the thigh link 11.

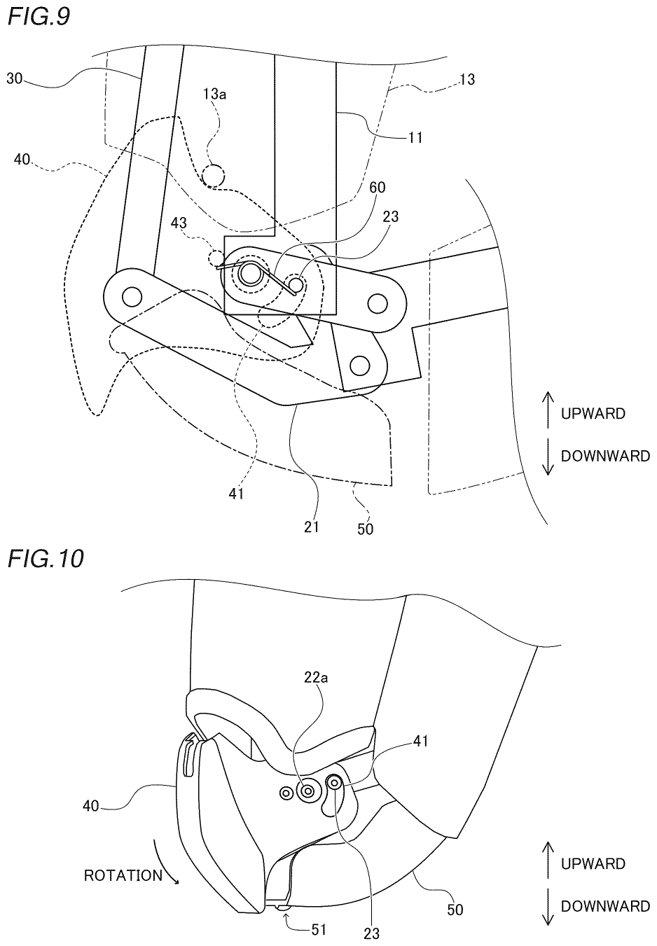

As shown in FIG. 9, throughout the range of rotation angles from 0 degrees to 100 degrees, the movable cover 40 is urged toward the thigh link 11 by the urger 60, such that the movable cover remains in contact with the protrusion 13a provided on the thigh cover 13, which covers the thigh link 11; and as a result, the movable cover maintains a fixed relative positional relationship with the thigh link 11. In other words, throughout the range of rotation angles from 0 degrees to 100 degrees, the movable cover 40 is in contact with the thigh cover 13.

As shown in FIG. 10, when the rotation angle becomes larger than 100 degrees, the protrusion 23 provided on the joint link 22 comes in contact with the upper-side one end of the inner circumferential surface of the elongated hole 41 such that the movable cover 40 moves to rotate about the shaft 22a as its rotation axis. Specifically, the rotation of the joint link 22 driven by the relative rotation between the thigh link 11 and the lower leg link 12 causes the protrusion 23 to rotate upward while in contact with the upward-side one end of the inner circumferential surface of the elongated hole 41. The rotation of the protrusion 23 causes the movable cover 40 to move toward the lower leg link 12 side using the shaft 22a as the rotation axis. Throughout the range of rotation angles from 100 degrees to 150 degrees, the movable cover 40 and the protrusion 23 are moved together by the urging force applied by the urger 60. Throughout the range of rotation angles from 100 degrees to 150 degrees, the movable cover 40 rotates together with the joint link 22 in response to the relative rotation between the thigh link 11 and the lower leg link 12. In other words, the movable cover 40 rotates relative to the thigh link 11 and the lower leg link 12 within a predetermined rotational angle range of the relative rotation between the thigh link 11 and the lower leg link 12.

When the thigh link 11 and the lower leg link 12 rotate from the bent state to the stretched state, the movable cover 40 also rotates together with the joint link 22 throughout the range of rotation angles from 150 degrees to 100 degrees. In addition, throughout the range of rotation angles from 100 degrees to 0 degrees, the movable cover 40 does not move relative to the thigh link 11. Throughout the range of rotation angles from 100 degrees to 0 degrees, the protrusion 23 moves within the elongated hole 41 against the urging force of the urger 60 in response to the relative rotation between the thigh link 11 and the lower leg link 12.

Here, throughout the range of rotation angles from 0 degrees to 100 degrees, when the thigh link 11 and the lower leg link 12 are rotated relative to each other to perform a bending motion, the urging force applied by the urger 60 acts as an assist force to assist in driving the joint 20.

In addition, the fixed cover 50 includes a pinching-preventer 51. The pinching-preventer 51 protrudes toward the movable cover 40 from the end of the fixed cover on the side toward which the movable cover 40 moves to cover the fixed cover when the fixed cover is exposed from the movable cover 40 to prevent pinching between the fixed cover 50 and the movable cover 40. In other words, a convex pinching-preventer 51 is provided at an upper-side end of the fixed cover 50, which is the thigh link 11 side. The pinching-preventer 51 is integrally formed with the fixed cover 50. The pinching-preventer 51 is a bump portion protruding toward the movable cover 40 at the thigh link 11 side end of the fixed cover 50 to reduce the distance between the fixed cover 50 and the movable cover 40. The pinching-preventer 51 is exposed from the movable cover 40 throughout the range of rotation angles from 150 degrees to approximately 100 degrees, and is covered by the movable cover 40 throughout the range of rotation angles smaller than approximately 100 degrees. Here, during the relative rotation between the thigh link 11 and the lower leg link 12, the movable cover 40 and the fixed cover 50 move in a separated state in which the movable cover and the fixed cover are not in contact with each other.

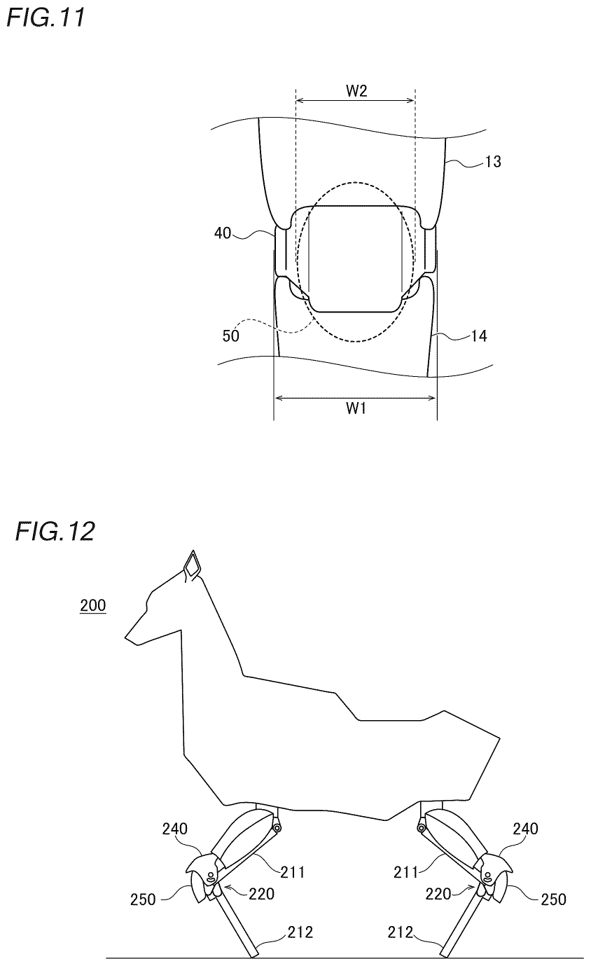

Here, as shown in FIG. 11, the movable cover 40 has a greater width W1 in an axial direction of rotation between the thigh link 11 and the lower leg link 12 than the fixed cover 50. In other words, as viewed from the front side of the humanoid robot 100, a width W1 of the movable cover 40 is greater than a width W2 of the fixed cover 50. Accordingly, when the thigh link 11 and the lower leg link 12 are aligned in substantially straight line as a stretched state, the fixed cover 50 is substantially entirely covered by the movable cover 40.

For example, as viewed from the front side of the humanoid robot 100, the fixed cover 50 is covered by the movable cover 40, the thigh cover 13 and the lower leg cover 14 when the rotation angle is 0 degrees.

### Advantages of the Embodiment

In this embodiment, as described above, the robot joint structure 100a of the humanoid robot 100 includes the movable cover 40 configured movably with respect to the joint 20 to move in response to relative rotation between the thigh link 11 as the first link and the lower leg link 12 as the second link and to cover the joint 20. Accordingly, because the movable cover 40 moves in response to the relative rotation between the thigh link 11 and the lower leg link 12, even when the position of a part to be protected, such as a rotation shaft in the joint 20, changes, the movable cover 40 can move in response to changes in the position of the part to be protected. Consequently, the part to be protected at the joint 20 can be covered by moving the movable cover 40 even when the position of the part to be protected changes without increasing the size of the movable cover 40.

Therefore, it is possible to prevent an increase in the size of the cover for the joint 20 connecting the links to each other.

Also, in this embodiment, as described above, the joint 20 includes a protrusion 23 as an engager driven by the driver 30 to move in response to the relative rotation between the thigh link 11 as the first link and the lower leg link 12 as the second link. The movable cover 40 includes the elongated hole 41 as an engagee engaging with the protrusion 23 to be moved in response to the relative rotation between the thigh link 11 and the lower leg link 12 when the protrusion 23 engages with the elongated hole 41. Accordingly, the movable cover 40 can be easily moved in response to the relative rotation between the thigh link 11 and the lower leg link 12 by engaging the protrusion 23 of the joint 20 with the elongated hole 41 of the movable cover 40. Consequently, the movable cover 40 can be easily moved, easily allowing for a structure capable of preventing an increase in the size of the movable cover 40.

Also, in this embodiment, as described above, the joint 20 includes the protrusion 23 as one selected from the group consisting of the convex protrusion 23 and the arc-shaped elongated hole 41 serving as the engager. The movable cover 40 includes the arc-shaped elongated hole 41 as another selected from the group consisting of the convex protrusion 23 and the arc-shaped elongated hole 41 serving as the engagee. The movable cover 40 moves to rotate in response to contact between the protrusion 23 and one end of an inner circumferential surface of the elongated hole 41. As a result, because the movable cover 40 can be moved by the contact the protrusion 23 with the one end of the inner circumferential surface of the arc-shaped elongated hole 41, the movement range of the movable cover 40 can be adjusted by changing the size of the elongated hole 41. Consequently, the movable cover 40 can accurately cover the part to be protected at the joint 20 in response to the movement of the joint 20 while preventing an increase in the size of the movable cover.

Also, in this embodiment, as described above, the movable cover 40 does not move while the protrusion 23 moves within the elongated hole 41 regardless of the relative rotation between the thigh link 11 as the first link and the lower leg link 12 as the second link, and the movable cover moves when the protrusion 23 contacts the one end of the inner circumferential surface of the elongated hole 41 in response to the relative rotation between the thigh link and the lower leg link. As a result, because the movable cover 40 does not move when the protrusion 23 moves within the elongated hole 41, it is possible to prevent that unnecessary movement of the movable cover 40 causes insufficient protection for the joint 20.

Also, in this embodiment, as described above, the robot joint structure 100a of the humanoid robot 100 includes the urger 60 that urges the movable cover 40 toward the thigh link 11 as the first link about a rotation axis of the movable cover 40. Accordingly, movement of the movable cover 40 relative to the thigh link 11 can be prevented by urging the movable cover by using the urger 60 when the protrusion 23 moves within the elongated hole 41. In addition, the movable cover 40 can be moved toward the lower leg link 12 side while the urger 60 limits relative movement between the protrusion 23 and the movable cover 40 when the protrusion 23 contacts the one end of the inner circumferential surface of the elongated hole 41. Accordingly, the movable cover 40 can be fixed relative to the thigh link 11 and moved together with the protrusion 23 by a simple configuration using the urger 60. As a result, the movable cover 40 can be easily positioned at a predetermined position as the thigh link 11 and the lower leg link 12 move relative to each other. In addition, because the urging force of the urger 60, which urges the movable cover 40 toward the thigh link 11, assists in driving the rotation when the thigh link 11 and the lower leg link 12 are rotated relative to each other to perform a bending motion, the load on the driver 30 can be reduced.

Also, in this embodiment, as described above, the joint 20 includes the joint link 22 as the third link connecting the thigh link 11 as the first link and the lower leg link 12 as the second link to each other. The protrusion 23 as the engager is provided on the joint link 22. The movable cover 40 includes the arc-shaped elongated hole 41 as the engagee, and moves in response to the contact between the protrusion 23, which is provided on the joint link 22, and the one end of the inner circumferential surface of the elongated hole 41. Here, the rotation angle can be increased by providing the joint link 22 connecting the thigh link 11 and the lower leg link 12 to each other in the joint 20, when the thigh link 11 and the lower leg link 12 are rotated relative to each other to perform a bending motion, as compared with a case where the thigh link 11 and the lower leg link 12 are directly connected to each other. In this case, an exposed portion of the joint 20 becomes larger because the rotation angle is increased between the thigh link 11 and the lower leg link 12 in the bending motion. To address this, in this embodiment, the movable cover 40 is moved by the contact between the protrusion 23, which is provided on the joint link 22, and the one end of the inner surface of the elongated hole 41, which is provided to the movable cover 40. As a result, because the movable cover 40 can move in response to the movement of the joint link 22, the movable cover 40 can effectively move to cover the joint 20 when the rotation angle becomes large in the rotation between the thigh link 11 and the lower leg link 12. Consequently, an increase in the size of the movable cover 40 can be effectively prevented.

Also, in this embodiment, as described above, the joint link 22 as the third link is rotatably connected to the thigh link 11 as the first link via the shaft 22a.

The movable cover 40 is connected to the shaft 22a and moves to rotate about a rotation axis shared with rotation of the joint link 22 relative to the thigh link 11. As a result, because the movable cover 40 can rotate about the rotation axis shared with the rotation of the joint link 22, the movable cover 40 can move to follow the joint link 22 in response to the movement of the joint link 22. Consequently, the movable cover 40 can easily move to cover the joint 20 in response to the movement of the joint link 22.

Also, in this embodiment, as described above, the robot joint structure 100a of the humanoid robot 100 includes the fixed cover 50 configured separately from the movable cover 40 to cover the joint 20 with the fixed cover being fixed to the joint 20. The thigh link 11 as the first link and the lower leg link 12 as the second link rotate relative to each other to perform bending and stretching motions. The fixed cover 50 is covered by the movable cover 40 when the thigh link 11 and the lower leg link 12 are in a stretched state. In addition, the fixed cover 50 is exposed from the movable cover 40 toward the lower leg link 12 when the thigh link 11 and the lower leg link 12 are in a bent state. Here, when the thigh link 11 and the lower leg link 12 both are brought from a stretched state into the bent state, the area of the exposed portion of the joint 20 increases. Accordingly, the area of the exposed portion of the joint 20 covered by the movable cover 40 and the fixed cover 50 can be increased in response to the bending and stretching motions by covering the fixed cover 50 by the movable cover 40 when the thigh link 11 and the lower leg link 12 both are brought from a stretched state and by exposing the fixed cover 50 from the movable cover 40 when they are in the bent state. As a result, because the size of the movable cover 40 can be reduced as compared with a case where no fixed cover 50 is provided, it is possible to further prevent an increase in the size of the movable cover 40.

Also, in this embodiment, as described above, the movable cover 40 has a greater width W1 in an axial direction of rotation between the thigh link 11 as the first link and the lower leg link 12 as the second link than the fixed cover 50. Accordingly, the entire fixed cover 50 can be covered by the movable cover 40. Here, if only a portion of the fixed cover 50 is covered by the movable cover 40 when the thigh link 11 and the lower leg link 12 both are in the stretched state, the sizes of the fixed cover 50 and the movable cover 40 are increased to cover a portion of the joint 20 to be protected when they are in the bent state. To address this, in this embodiment, the width W1 of the movable cover 40 is set to be larger than the width W2 of the fixed cover 50, and as a result, increases in the sizes of the fixed cover 50 and the movable cover 40 can be prevented.

Also, in this embodiment, as described above, the fixed cover 50 includes the pinching-preventer 51 that protrudes toward the movable cover 40 from the end of the fixed cover on the side toward which the movable cover 40 moves to cover the fixed cover when the fixed cover is exposed from the movable cover 40 to prevent pinching between the fixed cover and the movable cover 40.

Accordingly, the pinching-preventer 51, which protrudes toward the movable cover 40, can prevent foreign objects from being pinched between the movable cover 40 and the fixed cover 50. Consequently, it is possible to prevent abnormalities in the rotational movement between the thigh link 11 and the lower leg link 12 caused by foreign objects pinched between them.

Also, in this embodiment, as described above, the thigh link 11 as the first link and the lower leg link 12 as the second link rotate relative to each other to perform bending and stretching motions. The driver 30 includes a linear movement mechanism 31 having the linearly movable distal end 31a connected to the joint 20. Also, the driver 30 is arranged on a side opposite to a direction of rotation in which the thigh link 11 and the lower leg link 12 are rotated relative to each other to perform a bending motion. The movable cover 40 moves in response to the relative rotation between the thigh link 11 and the lower leg link 12 driven by the linear movement of the distal end 31a of the linear movement mechanism 31. Here, when the thigh link 11 and the lower leg link 12 are rotated by the linear movement mechanism 31 arranged on a side opposite in the rotation direction, the distal end 31a of the linear movement mechanism 31 on the opposite side in the rotation direction moves linearly toward the joint 20 connecting the thigh link 11 and the lower leg link 12. For this reason, the distal end 31a of the linear movement mechanism 31 is exposed on the opposite side of the joint 20 in the rotational direction. To address this, in this embodiment, the distal end 31a of the linear movement mechanism 31, which moves linearly on the opposite side of the joint 20 in the rotation direction, can be effectively covered by moving the movable cover 40 in response to the relative rotation between the thigh link 11 and the lower leg link 12 driven by the linear movement of the distal end 31a of the linear movement mechanism 31. Consequently, it is possible to effectively prevent external exposure of the linear movement mechanism 31 on the opposite side in the rotational direction.

Also, in this embodiment, as described above, the thigh link 11 as the first link is a component of the thigh 1 in the humanoid robot 100. The lower leg link 12 as the second link is a component of the lower leg 2 in the humanoid robot 100. The movable cover 40 is configured movably with respect to the joint 20 as the knee joint to move in response to the relative rotation between the thigh link 11 as the component of the thigh 1 and the lower leg link 12 as the component of the lower leg 2. Accordingly, the movable cover 40 can be moved in response to the rotation between the thigh link 11 and the lower leg link 12, which are components of the thigh 1 and lower leg 2 of the humanoid robot 100. Consequently, the joint 20 in the humanoid robot 100 can be effectively covered while preventing increases in the sizes of the movable cover 40 and fixed cover 50, which cover the joint 20.

### Modified Embodiments

Note that the embodiment disclosed this time must be considered as illustrative in all points and not restrictive. The scope of the present disclosure is not shown by the above description of the embodiments but by the scope of claims for patent, and all modifications (modified examples) within the meaning and scope equivalent to the scope of claims for patent are further included.

For example, while the example in which the movable cover 40 covering the joint 20 and the fixed cover 50 are provided in the robot joint structure 100a rotating the thigh link 11 as the first link of the thigh 1 and the lower leg link 12 as the second link of the lower leg 2 of the leg of the humanoid robot 100 relative to each other has been shown in the aforementioned embodiment, the present disclosure is not limited to this. In the present disclosure, the robot joint structure may rotate the first link and the second link relative to each other in a non-humanoid robot. For example, as in a robot joint structure according to a modified example shown in FIG. 12, when first links 211 and second links 212 are rotated relative to each other in legs of a robot 200, which is a four-legged robot, movable covers 240 and fixed covers 250 may be provided to joints 220, which connect the first links 211 and the second links 212 to each other. Here, the configurations of the joints 220, the movable cover 240 and the fixed cover 250 are the same as those of the joint 220, the movable cover 240 and the fixed cover 250 in the aforementioned embodiment. Accordingly, similar to the aforementioned embodiment, the movable covers 240 move in response to relative rotation between the first links 211 and second links 212. Also, when the first links and the second links are connected to and rotated relative to each other not in the legs of the humanoid robot but by elbow joints of arms of the humanoid robot, movable covers and fixed covers may be provided to joints serving as the elbow joints, which connect the first links and the second links to each other.

Also, while the example in which a convex protrusion 23, which is the engager provided on the joint link 22 as the third link of the joint 20, engages with the arc-shaped elongated hole 41, which is the engagee of the movable cover 40 has been shown in the aforementioned embodiment, the present disclosure is not limited to this. In the present disclosure, an elongated hole may be provided as an engager to the joint and a protrusion may be provided as an engagee to the movable cover. Also, the elongated hole may have a linear shape instead of an arc shape. Also, instead of the arc-shaped elongated hole as the engagee of the movable cover, a notch formed by cutting out a portion of the movable cover may be provided to engage with the engager. Also, the convex engagee may be provided to the movable cover, and the engager may be a notch formed by cutting out a portion of the third link.

Also, while the example in which the convex protrusion 23 is provided as the engager on the joint link 22 as the third link of the joint 20 has been shown in the aforementioned embodiment, the present disclosure is not limited to this. In the present disclosure, the engager may be provided to the other link of the joint. Also, an engager that engages with the engagee of the movable cover may be provided to a component other than the joint. For example, the engager may be provided to the second link. The engager may be provided to the fixed cover. The engager may be provided to a cover of the second link.

Also, while the example in which the movable cover 40 rotates relative to the thigh link 11 and the lower leg link 12 within a rotational angle range from 100 to 150 degrees, which is the predetermined rotational angle range of the relative rotation between the thigh link 11 as the first link and the lower leg link 12 as the second link, has been shown in the aforementioned embodiment, the present disclosure is not limited to this. In the present disclosure, the predetermined rotationally moving angle range of the movable cover may start at an angle smaller than 100 degrees or extend to an angle greater than 150 degrees. Alternatively, the predetermined rotational angle range may be a range greater than greater than 100 degrees or a range smaller than 150 degrees. Alternatively, the movable cover may be moved not within a part of the rotational angle range of the relative rotation between the first link and the second link but over the entire rotational angle range of the relative rotation between the first link and the second link. Alternatively, the relative rotation between the first link and the second link may not be the range from 0 to 150 degrees.

Also, while the example in which the movable cover 40 is urged by the urger 60, which is a torsion coil spring, has been shown in the aforementioned embodiment, the present disclosure is not limited to this. In the present disclosure, the urger may be a tensile coil spring, a plate spring, a spiral spring, or another metal spring. Also, the urger may be an elastic member, such as rubber, instead of a metal spring. Also, the urger may include a driver, such as a solenoid actuator, and driving force from the driver may be used to urge the movable cover.

Also, while the example in which the shaft 22a, which serves as the rotation axis of the joint link 22 as the third link with respect to the thigh link 11 as the first link, serves as the rotation axis of the movable cover 40 has been shown in the aforementioned embodiment, the present disclosure is not limited to this. In the present disclosure, the movable cover may have a rotation axis different from the third link. Also, the movable cover may be moved linearly instead of rotating.

Also, while the example in which the fixed cover 50 fixed to the joint 20 is provided separately from the movable cover 40 has been shown in the aforementioned embodiment, the present disclosure is not limited to this. In the present disclosure, no fixed cover may be provided. Alternatively, the fixed cover may be fixed not to the joint but to the second link. Alternatively, an additional movable cover may be provided movably relative to the joint, separate from the movable cover that is urged toward the first link side.

Also, while the example in which the bump-shaped pinching-preventer 51 is provided on the fixed cover 50 has been shown in the aforementioned embodiment, the present disclosure is not limited to this. In the present disclosure, the pinching-preventer may have a flange shape formed by bending the end of the fixed cover. Also, the pinching-preventer may be provided on the movable cover.

Also, while the example in which the joint 20 includes the two links, which are the joint link 21 and the joint link 22, has been shown in the aforementioned embodiment, the present disclosure is not limited to this. In the present disclosure, the joint may have no links. For example, the first link, which is the thigh, and the second link, which is the lower leg, in the humanoid robot may be directly connected via a joint, which is a shaft serving as a rotation axis.

Also, while the example in which the driver 30 is arranged on the side opposite to the direction of rotation in which the thigh link 11 as the first link and the lower leg link 12 as the second link are rotated relative to each other to perform a bending motion has been shown in the aforementioned embodiment, the present disclosure is not limited to this. In the present disclosure, the driver may be arranged on the forward side of the direction of rotation in which the first link and the second link are rotated relative to each other to perform the bending motion. Also, the driver may include a rotary transmission mechanism instead of the linear movement mechanism having the linearly movable distal end connected to the joint. In other words, the driver may cause the first link and the second link to rotate relative to each other by transmitting a rotational driving force of its electric motor as rotational movement.

### Modes

The aforementioned exemplary embodiment will be understood as concrete examples of the following modes by those skilled in the art.

### (Mode 1)

A robot joint structure includes a first link and a second link; a joint that connects the first link and the second link to each other; a driver that rotates the first link and the second link relative to each other; and a movable cover that is configured movably with respect to the joint to move in response to relative rotation between the first link and the second link to cover the joint.

### (Mode 2)

In the robot joint structure according to mode 1, the joint includes an engager that is driven by the driver to move in response to the relative rotation between the first link and the second link; and the movable cover includes an engagee that engages with the engager to be moved in response to the relative rotation between the first link and the second link by engagement of the engagee with the engager.

### (Mode 3)

In the robot joint structure according to mode 2, the engager includes one selected from a group consisting of a convex protrusion and an arc-shaped elongated hole; the engagee includes another selected from the group consisting of the convex protrusion and the arc-shaped elongated hole; and the movable cover moves to rotate in response to contact between the protrusion and one end of an inner circumferential surface of the elongated hole.

### (Mode 4)

In the robot joint structure according to mode 3, the movable cover does not move while the protrusion moves within the elongated hole regardless of the relative rotation between the first link and the second link; and the movable cover moves when the protrusion contacts the one end of the inner circumferential surface of the elongated hole in response to the relative rotation between the first link and the second link.

### (Mode 5)

In the robot joint structure according to mode 4, an urger that urges the movable cover toward the first link about a rotation axis of the movable cover is further provided.

### (Mode 6)

In the robot joint structure according to any of modes 3 to 5, the joint includes a third link that connects the first link and the second link to each other; the engager includes the protrusion, which is provided to the third link; the engagee includes the arc-shaped elongated hole; and the movable cover moves in response to the contact between the protrusion, which is provided to the third link, and the one end of the inner circumferential surface of the elongated hole.

### (Mode 7)

In the robot joint structure according to mode 6, the third link is rotatably connected to the first link via a shaft; and the movable cover is connected to the shaft and moves to rotate about a rotation axis shared with rotation of the third link relative to the first link.

### (Mode 8)

In the robot joint structure according to any of modes 1 to 7, a fixed cover that is configured separately from the movable cover to cover the joint with the fixed cover being fixed to the joint is further provided; the first link and the second link rotate relative to each other to perform bending and stretching motions; and the fixed cover is covered by the movable cover when the first link and the second link are in a stretched state, and is exposed from the movable cover toward the second link when the first link and the second link are in a bent state.

### (Mode 9)

In the robot joint structure according to mode 8, the movable cover has a greater width in an axial direction of rotation between the first link and the second link than the fixed cover.

### (Mode 10)

In the robot joint structure according to mode 8 or 9, the fixed cover includes a pinching-preventer that protrudes toward the movable cover from an end of the fixed cover on a side toward which the movable cover moves to cover the fixed cover when the fixed cover is exposed from the movable cover to prevent pinching between the fixed cover and the movable cover.

### (Mode 11)

In the robot joint structure according to mode any of modes 1 to 10, the first link and the second link rotate relative to each other to perform bending and stretching motions; the driver includes a linear movement mechanism having a linearly movable distal end connected to the joint, and is arranged on a side opposite to a direction of rotation in which the first link and the second link are rotated relative to each other to perform a bending motion; and the movable cover moves in response to the relative rotation between the first link and the second link driven by linear movement of the distal end of the linear movement mechanism.

### (Mode 12)

In the robot joint structure according to any of modes 1 to 11, the first link is a thigh in a humanoid robot; the second link is a lower leg in the humanoid robot; and the movable cover is configured movably with respect to the joint as a knee joint to move in response to relative rotation between the first link as the thigh and the second link as the lower leg.

### (Mode 13)

A robot includes a first link and a second link; a joint that connects the first link and the second link to each other; a driver that rotates the first link and the second link relative to each other; and a movable cover that is configured movably with respect to the joint to move in response to relative rotation between the first link and the second link to cover the joint.

1. A robot joint structure comprising:
a first link and a second link;
a joint that connects the first link and the second link to each other;
a driver that rotates the first link and the second link relative to each other; and
a movable cover that is configured movably with respect to the joint to move in response to relative rotation between the first link and the second link to cover the joint.

2. The robot joint structure according to claim 1, wherein
the joint includes an engager that is driven by the driver to move in response to the relative rotation between the first link and the second link; and
the movable cover includes an engagee that engages with the engager to be moved in response to the relative rotation between the first link and the second link by engagement of the engagee with the engager.

3.The robot joint structure according to claim 2, wherein
the engager includes one selected from a group consisting of a convex protrusion and an arc-shaped elongated hole;
the engagee includes another selected from the group consisting of the convex protrusion and the arc-shaped elongated hole; and
the movable cover moves to rotate in response to contact between the protrusion and one end of an inner circumferential surface of the elongated hole.

4. The robot joint structure according to claim 3, wherein the movable cover does not move while the protrusion moves within the elongated hole regardless of the relative rotation between the first link and the second link; and
the movable cover moves when the protrusion contacts the one end of the inner circumferential surface of the elongated hole in response to the relative rotation between the first link and the second link.

5. The robot joint structure according to claim 4 further comprising an urger that urges the movable cover toward the first link about a rotation axis of the movable cover.

6. The robot joint structure according to claim 3, wherein
the joint includes a third link that connects the first link and the second link to each other;
the engager includes the protrusion, which is provided to the third link;
the engagee includes the arc-shaped elongated hole; and
the movable cover moves in response to the contact between the protrusion, which is provided to the third link, and the one end of the inner circumferential surface of the elongated hole.

7. The robot joint structure according to claim 6, wherein
the third link is rotatably connected to the first link via a shaft; and
the movable cover is connected to the shaft and moves to rotate about a rotation axis shared with rotation of the third link relative to the first link.

8. The robot joint structure according to claim 1 further comprising a fixed cover that is configured separately from the movable cover to cover the joint with the fixed cover being fixed to the joint, wherein
the first link and the second link rotate relative to each other to perform bending and stretching motions; and
the fixed cover is covered by the movable cover when the first link and the second link are in a stretched state, and is exposed from the movable cover toward the second link when the first link and the second link are in a bent state.

9. The robot joint structure according to claim 8, wherein the movable cover has a greater width in an axial direction of rotation between the first link and the second link than the fixed cover.

10. The robot joint structure according to claim 8, wherein the fixed cover includes a pinching-preventer that protrudes toward the movable cover from an end of the fixed cover on a side toward which the movable cover moves to cover the fixed cover when the fixed cover is exposed from the movable cover to prevent pinching between the fixed cover and the movable cover.

11. The robot joint structure according to claim 1, wherein
the first link and the second link rotate relative to each other to perform bending and stretching motions;
the driver includes a linear movement mechanism having a linearly movable distal end connected to the joint, and is arranged on a side opposite to a direction of rotation in which the first link and the second link are rotated relative to each other to perform a bending motion; and
the movable cover moves in response to the relative rotation between the first link and the second link driven by linear movement of the distal end of the linear movement mechanism.

12. The robot joint structure according to claim 1, wherein
the first link is a thigh in a humanoid robot;
the second link is a lower leg in the humanoid robot; and
the movable cover is configured movably with respect to the joint as a knee joint to move in response to relative rotation between the first link as the thigh and the second link as the lower leg.

13. A robot comprising:
a first link and a second link;
a joint that connects the first link and the second link to each other;
a driver that rotates the first link and the second link relative to each other; and
a movable cover that is configured movably with respect to the joint to move in response to relative rotation between the first link and the second link to cover the joint.
